(19) United States
(12) Patent Application Publication
(10) Pub. No.: US 2022/0327390 A1
(43) Pub. Date: Oct. 13, 2022

(54) METHOD FOR TRAINING A NEURAL NETWORK

(71) Applicant: Robert Bosch GmbH, Stuttgart (DE)

(72) Inventors: Ben Wilhelm, Gundelsheim (DE); Frank Hutter, Freiburg Im Breisgau (DE); Matilde Gargiani, Freiburg (DE)

(21) Appl. No.: 17/657,403

(22) Filed: Mar. 31, 2022

(30) Foreign Application Priority Data
Apr. 13, 2021 (DE) 10 2021 109 169.1

(51) Int. Cl. G06N 3/08

(52) U.S. Cl. CPC G06N 3/084

(57) ABSTRACT

A method for training a neural network, which includes a first number of layers. In the method, in a training sequence, which includes a plurality of training patterns, using a backpropagation algorithm, when applying the backpropagation algorithm during each of the plurality of training patterns, in each case a second number of layers of the neural network being disregarded, an absolute value of the second number being variable and being randomly selected before each of the number of training patterns under the condition that the absolute value is greater than or equal to zero and simultaneously smaller than an absolute value of the first number, and the second number of layers being an input layer of the neural network and layers of the neural network immediately following the input layer.

### CROSS REFERENCE

The present application claims the benefit under 35 U.S.C. § 119 of German Patent Application No. DE 10 2021 109 169.1 filed on Apr. 13, 2021, which is expressly incorporated herein by reference in its entirety.

### FIELD

The present invention relates to a method for training a neural network, for example, a neural network for image classification, with which computer resources may be saved to a significant extent during the training of the neural network.

### BACKGROUND INFORMATION

In numerous fields, the application of neural networks has in the meantime replaced conventional evaluation methods for evaluating large volumes of data or is at least additionally included with the former. Neural networks, which have been trained based on a known volume of data, provide, in particular, more reliable conclusions for new input data of the same data type than the previous conventional evaluation methods.

Such artificial neural networks are oriented to biological neurons and allow an unknown system behavior to be trained from existing training data and the trained system behavior to be subsequently also applied to unknown input variables. The neural network in this case is made up of layers including idealized neurons, which are connected to one another in different ways according to a topology of the network. The first layer, also referred to as the input layer, detects and transfers in the process the input values, the number of the neurons in the input layer corresponding to the number of input signals that are to be processed. The last layer is also referred to as the output layer and includes just as many neurons as output values are to be provided. At least one intermediate layer, which is often also referred to as the hidden layer, is also situated between the input layer and the output layer, the number of intermediate layers and the number of neurons in these layers being a function of the specific task that is to be achieved by the neural network.

A basic condition for the use of such neural networks in this case is to adapt the neural network to the respective conditions and to train it accordingly.

A method for training a recurrent neural network during training sequences using a backpropagation algorithm is described in PCT Patent Publication No. WO 2017/201507 A1, a training sequence, which includes in each case one input to each of a number of time steps, being received, data, which relate to an available memory capacity for storing pieces of forward propagation information that may be applied during an application of the backpropagation algorithm being obtained, a strategy for processing the training sequence being determined based on the number of time steps in the training sequence and on the available memory capacity for storing, the strategy specifying when the pieces of forward propagation information are to be saved during the application of a forward propagation algorithm to the training sequence, and the recurrent neural network being trained according to the strategy based on the training sequence.

An object of the present invention is to specify a method for training a neural network, with which computer resources may be saved to a significant extent during the training of the neural network.

The object may be achieved by a method for training a neural network in accordance with the present invention. Advantageous specific embodiments and refinements of the present invention are described herein with reference to the figures.

In accordance with an example embodiment of the present invention, a method is provided for training a neural network, which includes a first number of layers, in a training sequence, which includes a plurality of training patterns, using a backpropagation algorithm, when applying the backpropagation algorithm during each of the plurality of training patterns, a second number of layers of the neural network in each case being disregarded, an absolute value of the second number being variable and being randomly selected before each of the number of training patterns under the condition that the absolute value is greater than or equal to zero and simultaneously smaller than an absolute value of the first number, and the second number of layers being an input layer of the neural network and layers of the neural network immediately following the input layer.

A training sequence in this case is understood to mean a sequence of consecutively applied training patterns for training the neural network.

A backpropagation algorithm is further understood to mean an algorithm for teaching artificial neural networks. In the process, an input pattern is initially applied and propagated forward by the neural network with the aid of a forward propagation algorithm. The output of the neural network is subsequently compared with a desired output, the difference between the two values being identified as an error of the network. This error is then propagated via the output layer back to the input layer of the neural network, the weightings of the neural connections being changed as a function of their influence on the error. This results in a renewed application of the input roughly in an approximation of the desired output.

Forward propagation further means that an input pattern or input values is/are applied, which are propagated forward by the artificial neural network and in the process generate output values.

Because the individual layers continue to be disregarded during the application of the backpropagation algorithm, i.e., are disregarded or “frozen,” this further means that the corresponding layers and corresponding weightings are not examined or changed during the application of the backpropagation algorithm. In the process, the weights assigned to the corresponding layers and connections either remain unchanged or a momentum used for determining the weights is frozen or remains unchanged during the application of the backpropagation algorithm. However, the output values generated during a previous application of the forward propagation algorithm and corresponding weightings of the connections assigned to these layers during the application of the backpropagation algorithm may still be taken into account.

One feature of the present invention is to accelerate significantly the backpropagation algorithm when training a neural network, particularly since the weightings of all connections no longer have to be examined or changed during an application of the backpropagation algorithm and instead, the backpropagation algorithm is able to settle earlier. This in turn results in a significant savings of corresponding computer resources, in particular, of computing time and required computing power as well as of required memory capacities. The fact that computing time and computing power are saved has the advantage that the neural network is trained relatively rapidly, which is advantageous, in particular, in safety-critical applications, for example, in control tasks of autonomously driving motor vehicles.

The fact that memory capacities are saved also has the advantage that the training may also be carried out completely on data processing units that have a comparatively small memory capacity, for example, on control units of a motor vehicle. In addition, the method is less inflexible compared to methods in which individual layers in a strict order are disregarded or are “frozen,” and thus has the advantage that performance losses may be avoided, particularly since the input layer is also almost always able to contribute to the success or to the minimization of the error. Thus, on the whole, a method for training a neural network is specified, with which computer resources may be saved to a significant extent during the training of the neural network.

In accordance with an example embodiment of the present invention, the method may further include a step of establishing a learning rate for each layer of the neural network, the determination of the absolute value of the second number further taking place in each case under the condition that each layer of the neural network is trained on the whole just as frequently during the training sequence as is specified by a frequency value based on the learning rate of the corresponding layer.

The learning rate in this case represents a parameter, which indicates the speed of the method with respect to individual layers of the neural network. The learning rate in this case may be deduced, for example, from methods, in which individual layers in a strict order are disregarded or are “frozen,” it being possible to derive from this learning rate the frequency value, and the frequency value indicating how frequently the corresponding layer must be trained during the training sequence of the neural network until it converges, i.e., the corresponding error ideally approaches zero.

This may further enhance the efficiency of the method. In addition, the saving of computer resources may be still further optimized, in particular, with respect to computing time and memory capacity based on the fact that later layers converge later due to more complex pieces of information and require more training than earlier layers.

In addition, a forward propagation algorithm may be applied after each application of the backpropagation algorithm, the layers of the neural network, which are disregarded during an application of the backpropagation algorithm, also being disregarded during a following application of the forward propagation algorithm, in the following application of the forward propagation algorithm, being reused, i.e., applied or taken into account instead from a preceding application of the forward propagation algorithm to the layers of the neural network, which are disregarded during an application of the backpropagation algorithm. Memory capacity may be saved to a significant extent as a result, particularly since significantly fewer weightings are examined or changed, which is advantageous, in particular, if the method is to be carried out completely on data processing systems having a small memory capacity, for example, on control units in a motor vehicle.

The method may also be combined with other methods for training artificial neural networks.

Thus, the method may be applied to another data set during a retraining of a neural network pre-trained on a first data set.

During such a retraining of a neural network, a neural network pre-trained on a first data set, for example, motor vehicles, is retrained on another data set, which exhibits similarities to the first data set, for example, trucks, which facilitates significantly the training of the neural network.

As a result of this combination, the accuracy of the fine-tuning of the corresponding retrained neural network may be increased or a corresponding fine-tuning process may be accelerated. Thus, the accuracy of the output of the retrained neural network and, for example, of corresponding data output at control units of a motor vehicle may be increased which, in turn, results in the increase in safety when driving the motor vehicle.

The method may also be applied during a training of a neural network that has already been trained, but with other parameters.

In such a warm-starting, input values or weightings that have been trained with other parameters may be directly adopted.

In this way, the resources required for training or for further training of a neural network, which has already been pre-trained with other parameters, in particular, with respect to computing time, computing power and memory capacities may, in turn, be significantly reduced, so that the neural network may, for example, also be (fully) trained completely on a data processing unit that has a comparatively small memory capacity, for example, on a control unit of a motor vehicle.

In addition, a method for classifying image data is also specified with a further specific embodiment of the present invention, image data being classified using a neural network, which is trained to classify image data, and the neural network having being trained using an above-described method.

The method may be used, in particular, to classify image data, in particular, digital image data on the basis of low-level features, for example, edges or pixel attributes. In this method, an image processing algorithm may further be used in order to analyze a classification result that is focused on corresponding low-level features.

Such a method has the advantage that computer resources, in particular, computing time, computing power and memory capacities may be saved to a significant degree during the training of the corresponding neural network, the neural network being able to be rapidly adapted to the corresponding purpose, i.e., for image classification. Thus, the training method is designed, in particular, in such a way that the corresponding backpropagation algorithm may be greatly accelerated, particularly since the weightings of all connections no longer have to be examined or changed during an application of the backpropagation algorithm and instead, the backpropagation algorithm is able to settle earlier. In addition, the method is less inflexible compared to methods in which individual layers in a strict order are disregarded or are “frozen,” and thus has the advantage that performance losses may be avoided, particularly since the input layer is also almost always able to contribute to the success or to the minimization of the error.

The object may also be achieved with a computer program and a computer-readable data medium.

Such a computer program has the advantage that with these significant computer resources, computing time, computing power and memory capacities, in particular, may be saved during the training of a neural network. Thus, the corresponding training method is designed, in particular, in such a way that the backpropagation algorithm may be greatly accelerated, particularly since the weightings of all connections no longer have to be examined or changed during an application of the backpropagation algorithm and instead, the backpropagation algorithm is able to settle earlier. The fact that computing time and computing power are saved has the advantage that the neural network is trained relatively rapidly, which is advantageous, in particular, in safety-critical applications, for example, in control tasks of autonomously driving motor vehicles.

The fact that memory capacities are saved also has the advantage that the training may also be carried out completely on data processing units that have a comparatively small memory capacity, for example, on control units of a motor vehicle. In addition, the method is less inflexible compared to methods in which individual layers in a strict order are disregarded or are “frozen,” and thus has the advantage that performance losses may be avoided, particularly since the input layer is also almost always able to contribute to the success or to the minimization of the error.

A control unit for training a neural network is also specified with one further specific embodiment of the present invention, the control unit being designed to carry out an above-described method.

Such a control unit has the advantage of being designed in such a way that computer resources, in particular, computing time, computing power and memory capacities may be saved to a significant degree during the training of a neural network. Thus, the control unit is designed, in particular, in such a way that the backpropagation algorithm may be greatly accelerated, particularly since the weightings of all connections no longer have to be examined or changed during an application of the backpropagation algorithm and instead, the backpropagation algorithm is able to settle earlier. The fact that computing time and computing power are saved has the advantage that the neural network is trained relatively rapidly, which is advantageous, in particular, in safety-critical applications, for example, in control tasks of autonomously driving motor vehicles.

The fact that memory capacities are saved also has the advantage that the training may also be carried out completely on data processing units that have a comparatively small memory capacity, for example, on control units of a motor vehicle. In addition, the control unit is less inflexible compared to control units, which are designed to disregard or to “freeze” individual layers in a strict order during the training of a neural network, as a result of which performance losses may be avoided, particularly since the input layer is also almost always able to contribute to the success or to the minimization of the error.

In addition, a system for classifying image data is also specified with one further specific embodiment of the present invention, the system including at least one optical sensor, which is designed to provide image data, and a control unit described above, the control unit being designed to classify image data provided by the at least one optical sensor.

Such a system has the advantage of including a control unit, which is designed in such a way that, computer resources, in particular, computing time, computing power and memory capacities may be saved to a significant degree during the training of a neural network. Thus, the control unit is designed, in particular, in such a way that the backpropagation algorithm may be greatly accelerated, particularly since the weightings of all connections no longer have to be examined or changed during an application of the backpropagation algorithm and instead, the backpropagation algorithm is able to settle earlier. In addition, the control unit is less inflexible during the training of a neural network compared to control units, which are designed to disregard or to “freeze” individual layers in a strict order, as a result of which performance losses may be avoided, particularly since the input layer is also almost always able to contribute to the success or to the minimization of the error.

The embodiments and refinements described may be arbitrarily combined with one another.

Further possible embodiments, refinements and implementations of the present invention also include combinations not explicitly mentioned of features of the present invention described above or below with reference to the exemplary embodiments.

### BRIEF DESCRIPTION OF THE DRAWINGS

The figures are intended to convey a further understanding of the specific embodiments of the present invention. They illustrate specific embodiments and are used in conjunction with the description to explain principles and features of the present invention.

Other specific embodiments and many of the cited advantages result with respect to the figures. The elements of the figures represented are not necessarily shown true to scale to one another.

FIG. 1 shows a flowchart of a method for training a neural network according to specific embodiments of the present invention.

FIG. 2 shows a method for training a neural network according to one first specific embodiment of the present invention.

FIG. 3 shows a method for training a neural network according to one second specific embodiment of the present invention.

FIG. 4 shows a block diagram of a system for classifying image data according to specific embodiments of the present invention.

### DETAILED DESCRIPTION OF EXAMPLE EMBODIMENTS

In the figures, identical reference numerals refer to identical or functionally identical elements, parts or components unless indicated otherwise.

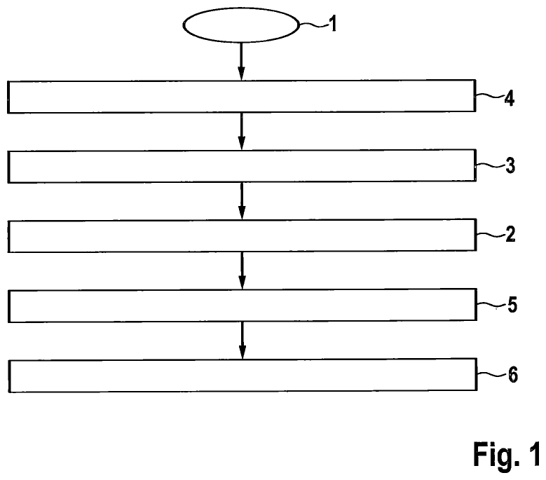

FIG. 1 shows a flowchart of a method 1 for training a neural network according to specific embodiments of the present invention.

In numerous fields, the application of neural networks has in the meantime replaced conventional evaluation methods for evaluating large volumes of data or is at least additionally included with the former. Neural networks, which have been trained based on a known volume of data, provide, in particular, more reliable conclusions for new input data of the same data type than the previous conventional evaluation methods.

Such artificial neural networks are oriented to biological neurons and allow an unknown system behavior to be trained from existing training data and the trained system behavior to be subsequently also applied to unknown input variables. The neural network in this case is made up of layers including idealized neurons, which are connected to one another in different ways according to a topology of the network. The first layer, also referred to as the input layer, detects and transfers in the process the input values, the number of the neurons in the input layer corresponding to the number of input signals that are to be processed. The last layer is also referred to as the output layer and includes just as many neurons as output values are to be provided. At least one intermediate layer, which is often referred to as the hidden layer, is also situated between the input layer and the output layer, the number of intermediate layers and the number of neurons in these layers being a function of the specific task that is to be achieved by the neural network.

An idealized neuron in this case may be defined by its weighted connections, which serve as inputs, and a transfer function, which describes how the excitations are to be processed by the inputs in the neuron. The transfer functions in this case may be provided, for example, in the form of Sigmoid functions. In addition, one constant variable each of the neuron may be used to set how the corresponding inputs are transferred into a desired reference value. In this case, such constant variables constitute a further degree of freedom and have a positive influence on the ability to carry out approximations of system behaviors.

To train individual neurons or their weights to the neurons of the previous layer, a gradient(descent) method may be used, which is made up of an application of a forward propagation algorithm and subsequent applications of a backpropagation algorithm. In this method, an input pattern is initially applied and propagated forward through the neural network with the aid of the forward propagation algorithm. Upon application of the backpropagation algorithm, the output of the neural network is subsequently compared with a desired output, the difference between the two values being identified as an error of the network. This error is then propagated back via the output layer to the input layer of the neural network, the weightings of the neural connections being changed as a function of their influence on the error. This results in a renewed application of the input at this point in an approximation of the desired output.

Furthermore, the momentum term in this case may also be optimized, i.e., a value, which accumulates the gradients that are determined for the weightings, and which may accordingly be taken into account when changing the weightings.

FIG. 1 in this case shows a method 1 for training a neural network, which includes a first number of layers and, in particular, at least one intermediate layer, in a training sequence, which includes a number of training patterns, using a backpropagation algorithm.

According to the specific embodiments of FIG. 1, during a step 2 of applying the backpropagation algorithm during each of the plurality of training patterns, a second number of layers of the neural network in each case is disregarded, an absolute value of the second number being variable and being randomly selected in a step 3 before each of the number of training patterns under the condition that the absolute value is greater than or equal to zero and simultaneously smaller than an absolute value of the first number, and the second number of layers being an input layer of the neural network and layers of the neural network immediately following the input layer.

The fact that individual layers continue to be disregarded during the application of the backpropagation algorithm, i.e., disregarded or “frozen,” means in this case that the corresponding layers and corresponding weightings are not examined during the application of the backpropagation algorithm. The weights assigned to the corresponding layers and connections in this case either remain unchanged or a momentum used for determining the weights is frozen or remains unchanged during the application of the backpropagation algorithm. However, the output values generated during a previous application of the forward propagation algorithm and corresponding weightings of the layers during the application of the backpropagation algorithm may still be taken into account. The gradient of the corresponding connections in this case, i.e., the gradient of connections between layers that are disregarded is, in particular, set to zero during the application of the backpropagation algorithm, i.e., that also no corresponding gradient calculation is to be carried out. Based on the fact that the gradient calculation with respect to the corresponding connections is switched off, it is possible in this case either not to change the corresponding weights or to “freeze,” i.e., not to change the corresponding momentum term.

As shown in FIG. 1, method 1 further shows a step 4 of establishing a learning rate for each layer of the neural network, the determination of the absolute value of the second number further taking place in each case under the condition that each layer of the neural network is trained on the whole just as frequently during the training sequence as is specified by a frequency value based on the learning rate of the corresponding layer.

The learning rate in this case represents a parameter, which indicates the speed of the method with respect to individual layers of the neural network. The learning rate in this case may be deduced, for example, from methods, in which individual layers in a strict order are disregarded or are “frozen,” it being possible to derive from this learning rate the frequency value, and the frequency value indicating how frequently the corresponding layer must be trained during the training sequence of the neural network until it converges, i.e., the corresponding error ideally approaches zero.

If, for example, the frequency rate indicates that a particular layer of the neural network is to be trained during 70% of the training pattern, this means that the corresponding layer does not have to be trained in 30% of the training pattern. This may, in turn, be equated with the fact that the corresponding layer is disregarded during 30% of the training pattern when applying the backpropagation algorithm.

According to the specific embodiments of FIG. 1, method 1 is further designed to train with mini-batches, i.e., a data set to be trained may be divided into multiple parts.

Method 1 shown in FIG. 1 may also be combined with other methods for training artificial neural networks.

Method 1 may, for example, be carried out on another data set during a retraining of a neural network pre-trained on a first data set.

Method 1 may, however, also be applied during a so-called warm-starting, i.e., during a training of a neural network that has already been trained, but with other parameters.

According to the specific embodiments of FIG. 1, a neural network is trained to classify image data. FIG. 1 in this case shows an additional step 5 of receiving image data, the image data being classified in a following step 6 using the neural network.

Method 1 is used in this case, in particular, to classify image data, in particular, digital image data on the basis of low-level features, for example, of edges or pixel attributes. In this case, an image processing algorithm may further be used in order to analyze a classification result, which is focused on corresponding low-level features. The received image data serve in this case as input data for training the corresponding neural network.

The method according to the specific embodiments of FIG. 1 may, however, further be correspondingly used to train neural networks for classifying videos, audio signals and voice signals on the basis of low-level features.

In addition, the method according to the specific embodiments of Figure [sic; 1] may, however, further be used, for example, to train a neural network in such a way as to derive from learning data rules for the control tasks of an autonomous control system.

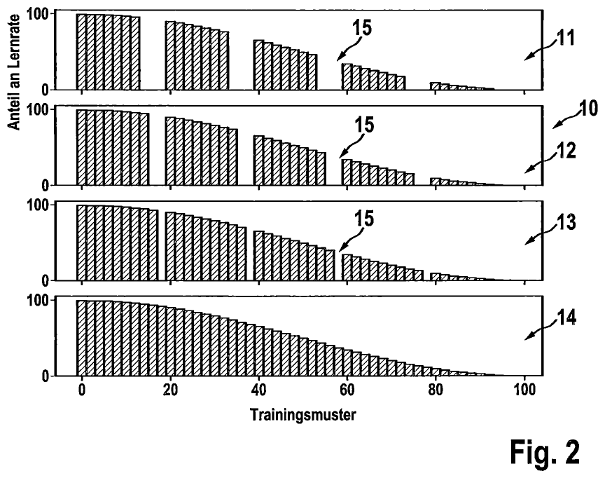

FIG. 2 illustrates a method 10 for training a neural network according to one first specific embodiment.

The neural network in this case includes four layers 11, 12, 13, 14 according to the first specific embodiment, first layer 11 being an input layer of the neural network and fourth layer 14 being an output layer of the neural network.

FIG. 2 shows, in particular, a method 10 for training a neural network, the training patterns, during which corresponding layer 11, 12, 13, 14 is taken into account during the application of a backpropagation algorithm, being represented for each layer 11, 12, 13, 14 of the neural network in a diagram with respect to the respectively associated portion of the learning rate of corresponding layer 11, 12, 13, 14. The abscissa here indicates in each case the corresponding training patterns during a training sequence. The corresponding portions of the learning rate of the corresponding layer still to be trained are indicated in each case on the ordinate.

As is apparent, fourth layer 14 in this case is taken into account during all training patterns when applying the backpropagation algorithm in order to ensure the desired convergence of the error.

As is further apparent, previous layers 11, 12, 13 of the neural network are not, however, taken into account during all training patterns when applying the backpropagation algorithm, layers 11, 12, 13 being all the more rarely taken into account the closer these layers are to the input of the neural network. This takes advantage of the effect that layers situated closer to the input of the neural network converge earlier, whereas later layers carry more complex pieces of information, which is why more training is required here. For example, the layers situated close to the input of a corresponding neural network recognize complex shapes within an image significantly earlier than layers of the neural network situated close to the output.

For example, third layer 13 in this case is disregarded during a training pattern 15. As shown in FIG. 2, the previous layers in this case on which the weightings of the connections of second layer 12 are based are also disregarded during training pattern 15. Input layer 11 of the neural network and immediately following layers 12, 13 of the neural network, in particular, are disregarded during training pattern 15.

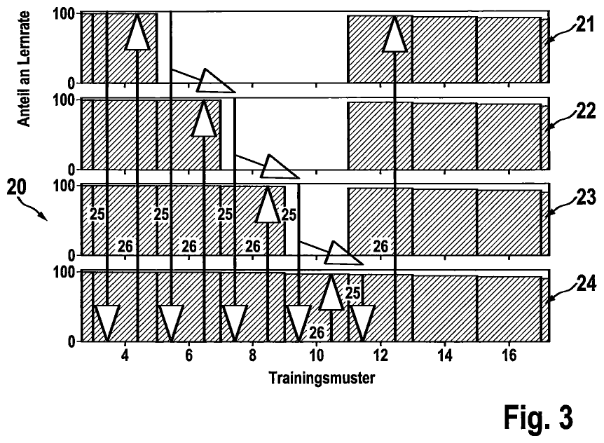

FIG. 3 illustrates a method 20 for training a neural network according to one second specific embodiment.

In this case, the neural network according to the second specific embodiment includes four layers 21, 22, 23, 24, first layer 21 being an input layer of the neural network and fourth layer 24 being an output layer of the neural network.

FIG. 3 shows, in particular, a method 20 for training a neural network, the training patterns, during which corresponding layer 21, 22, 23, 24 is taken into account during the application of a backpropagation algorithm, being represented for each layer 21, 22, 23, 24 of the neural network in a diagram with respect to the respectively associated portion of the learning rate of corresponding layer 21, 22, 23, 2, the diagrams are each a detail of the diagrams illustrated in FIG. 2. The abscissa again indicates in each case the corresponding number of training patterns during a training sequence. The corresponding portions of the learning rate of the corresponding layer still to be trained are indicated in each case on the ordinate.

As is apparent, FIG. 3 again shows a method, in which when applying the backpropagation algorithm during each of the number of training patterns, a second number of layers of the neural network in each case is disregarded, an absolute value of the second number being variable and being randomly selected before each of the number of training patterns under the condition that the absolute value is greater than or equal to zero and simultaneously smaller than an absolute value of the first number, and the second number of layers being an input layer of the neural network and layers of the neural network immediately following the input layer.

As is further apparent, a forward propagation algorithm is applied in method 20 according to the second specific embodiment after each application of the backpropagation algorithm, the layers of the neural network, which are disregarded during an application of the backpropagation algorithm, also being disregarded in a following application of the forward propagation algorithm, in the following application of the forward propagation algorithm, values obtained from a preceding, in particular, immediately preceding application of the forward propagation algorithm on the layers of the neural network, which are disregarded during an application of the backpropagation algorithm instead being reused. The application of the backpropagation algorithm in this case is symbolized in FIG. 3 by the arrows provided with reference numeral 25, whereas the following application of the forward propagation algorithm in FIG. 3 is symbolized by the arrows provided with reference numeral 26.

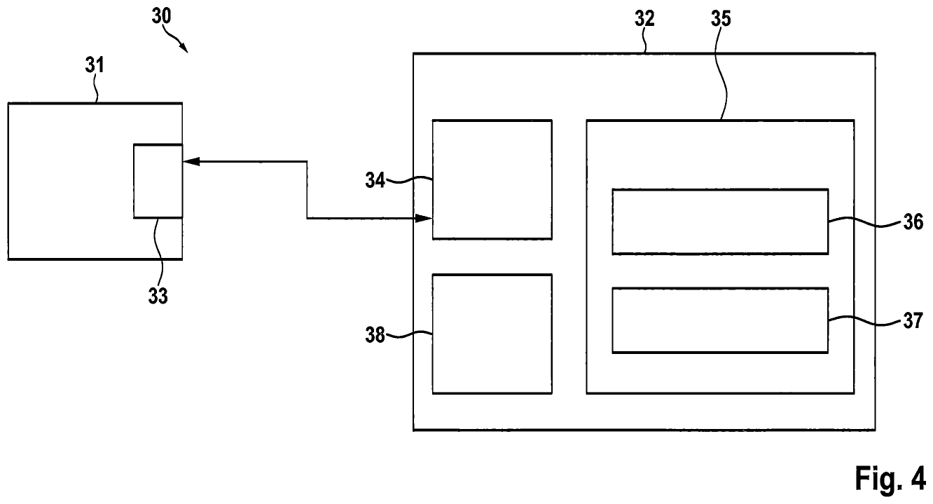

FIG. 4 shows a block diagram of a system 30 for classifying image data according to specific embodiments of the present invention.

As shown in FIG. 4, system 30 in this case includes an optical sensor 31 and a control unit 32.

Optical sensor 31 in this case is, in particular, an imaging sensor, which is designed to provide image data, for example, a camera. The optical sensor may, however also be any other optical sensor, which is designed to provide image data, for example, a LIDAR or a radar. The optical sensor in this case further includes an emitter 33, which is designed to transfer image data to the control unit in a wireless or hardwired manner.

Control unit 32 is further designed to classify image data provided by optical sensor 31.

According to the specific embodiments of FIG. 4, the control unit in this case includes a receiver 34, which is designed to receive image data provided and transferred by optical sensor 31, as well as a data processing unit 35, which is designed to train a neural network for classifying image data based on the image data provided and transferred by optical sensor 31 as well as on preceding image classifications, i.e., classifications carried out by a user in the past.

As is apparent, data processing unit 35 in this case includes, in particular, a memory 36, in which code executable by a processor 37 is stored.

Stored in memory 36 is, in particular, code, which is executable by processor 37, for training a neural network, which includes a first number of layers and, in particular, at least one intermediate layer, in a training sequence, which includes a number of training patterns, using a backpropagation algorithm, when applying the backpropagation algorithm during each of the plurality of training patterns, in each case a second number of layers of the neural network being disregarded, an absolute value of the second number being variable and being randomly selected before each of the plurality of training patterns under the condition that the absolute value is greater than or equal to zero and simultaneously smaller than an absolute value of the first number, and the second number of layers being an input layer of the neural network and layers of the neural network immediately following the input layer.

According to the specific embodiments of FIG. 4, the trained neural network is subsequently stored in a memory 38.

What is claimed is:

1. A method for training a neural network, which includes a first number of layers, the method comprising:
using, in a training sequence which includes a plurality of training patterns, a backpropagation algorithm; and
disregarding, when applying the backpropagation algorithm during each of the plurality of training patterns, a second number of layers of the neural network, an absolute value of the second number being variable and being randomly selected before each of the plurality of training patterns under a condition that the absolute value is greater than or equal to zero and simultaneously smaller than an absolute value of the first number, and the second number of layers including an input layer of the neural network and layers of the neural network immediately following the input layer.

2. The method as recited in claim 1, further comprising:
establishing a learning rate for each layer of the neural network, and determination of the absolute value of the second number further taking place in each case under the condition that each layer of the neural network is trained just as frequently during the training sequence as is specified by a frequency value based on the established learning rate of the layer.

3. The method as recited in claim 1, wherein a forward propagation algorithm is applied after each application of the backpropagation algorithm, and the layers of the neural network, which are disregarded during an application of the backpropagation algorithm, are also disregarded during a following application of the forward propagation algorithm, and wherein during the following application of the forward propagation algorithm, values obtained from a preceding application of the forward propagation algorithm to the layers of the neural network, which are disregarded during an application of the backpropagation algorithm, instead being reused.

4. The method as recited in claim 1, wherein the method is applied to another data set during a retraining of a neural network pre-trained on a first data set.

5. The method as recited in claim 1, wherein the method is applied during a training of a neural network that has already been trained, but with other parameters.

6. A method for classifying image data, the method comprising:
training a neural network having a first number of layers, the training including:
using, in a training sequence which includes a plurality of training patterns, a backpropagation algorithm, and
disregarding, when applying the backpropagation algorithm during each of the plurality of training patterns, a second number of layers of the neural network, an absolute value of the second number being variable and being randomly selected before each of the plurality of training patterns under a condition that the absolute value is greater than or equal to zero and simultaneously smaller than an absolute value of the first number, and the second number of layers including an input layer of the neural network and layers of the neural network immediately following the input layer; and
classifying image data using the trained neural network.

7. A non-transitory computer-readable data medium on which are stored program code of a computer program training a neural network, which includes a first number of layers, the program code, when executed by a computer, causing the computer to perform the following steps:
using, in a training sequence which includes a plurality of training patterns, a backpropagation algorithm; and
disregarding, when applying the backpropagation algorithm during each of the plurality of training patterns, a second number of layers of the neural network, an absolute value of the second number being variable and being randomly selected before each of the plurality of training patterns under a condition that the absolute value is greater than or equal to zero and simultaneously smaller than an absolute value of the first number, and the second number of layers including an input layer of the neural network and layers of the neural network immediately following the input layer.

8. A control unit configured to train a neural network, the neural network including a first number of layers, the control unit configured to:
use, in a training sequence which includes a plurality of training patterns, a backpropagation algorithm; and
disregard, when applying the backpropagation algorithm during each of the plurality of training patterns, a second number of layers of the neural network, an absolute value of the second number being variable and being randomly selected before each of the plurality of training patterns under a condition that the absolute value is greater than or equal to zero and simultaneously smaller than an absolute value of the first number, and the second number of layers including an input layer of the neural network and layers of the neural network immediately following the input layer.

9. A system for classifying image data, the system comprising:
at least one optical sensor configured to provide image data; and
a control unit configured to classify image data provided by the at least one optical sensor, using a trained neural network, the training including:
training a neural network having a first number of layers, the neural network being trained by:
using, in a training sequence which includes a plurality of training patterns, a backpropagation algorithm, and
disregarding, when applying the backpropagation algorithm during each of the plurality of training patterns, a second number of layers of the neural network, an absolute value of the second number being variable and being randomly selected before each of the plurality of training patterns under a condition that the absolute value is greater than or equal to zero and simultaneously smaller than an absolute value of the first number, and the second number of layers including an input layer of the neural network and layers of the neural network immediately following the input layer.
